(19) United States
(12) Patent Application Publication
(10) Pub. No.: US 2013/0254156 A1
(43) Pub. Date: Sep. 26, 2013

(54) Algorithm and System for Automated Enterprise-wide Data Quality Improvement

(71) Applicant: SYED ASIM H. ABBASI, East Brunswick, NJ (US)

(72) Inventor: SYED ASIM H. ABBASI, East Brunswick, NJ (US)

(21) Appl. No.: 13/429,324

(22) Filed: Mar. 24, 2012

(51) Int. Cl. G06F 17/30

(52) U.S. Cl. CPC G06F 17/30371
USPC 707/602

(57) ABSTRACT

Algorithm and System for Automated Enterprise-wide Data Quality Improvement by creating an infrastructure where error patterns can be stored in SQL statement format to system's local repository, in this way system can identify data errors either coming directly through keyboard entries or coming from another system through an automated feeds or manual feeds. The system automatically scans for erroneous records based on those error patterns and emails only faulty records in encrypted MS Excel format to correction agents for review and update to the production RDBMS.

### CROSS-REFERENCE TO RELATED APPLICATIONS

Lots of work has been done in the field of data entry error detection at the online form level a.k.a. form level data validation and data quality improvement utilizing different techniques e.g. double data entry which in itself time consuming, providing summary pages before submission of online form etc. I would like to put a reference to the following patents that contains the prior work done in the data quality improvement, data entry error detection and distribution fields:
U.S. Pat. No. 8,046,385 entitled “Data quality tracking”
U.S. Pat. No. 7,496,610 entitled “Computer system for portable digital data capture and data distribution”
U.S. Pat. No. 7,197,542 entitled “System and method for signaling quality and integrity of data content”
U.S. Pat. No. 6,915,454 entitled “Web controls validation”
U.S. Pat. No. 6,560,598 entitled “Internal database validation”
U.S. Pat. No. 5,940,847 entitled “System and method for automatically correcting multi-word data entry errors”

### STATEMENT REGARDING FEDERALLY SPONSORED RESEARCH OR DEVELOPMENT

Not Applicable

### REFERENCE TO SEQUENCE LISTING, A TABLE OR A COMPUTER PROGRAM LISTING COMPACT DISK APPENDIX

Not Applicable

### BACKGROUND OF INVENTION

The present invention is related to improving data quality in an enterprise-wide setup by identifying data entry errors either coming directly through keyboard entries or coming from another system through automated feeds or manual feeds. The identified records are then encrypted and emailed over to the pre-designated correction agent for review and updating production databases.

Prior to this claimed invention, the different techniques available for data quality improvement are related to individual Information Technology (IT) systems e.g. providing client-side and/or server-side data validation, double data entry, providing summary/review page before final submission, having another person review/approve the submitted data etc. What our extensive research concluded that no one discussed the situation where in an enterprise, with heterogeneous third party vendors' (not home grown) based softwares all over; how to develop an automated secure algorithm and system to provide added layer of data quality improvement at the Relational Database Management Systems (RDBMS) level.

In an enterprise environment, every time one department comes across a data entry error in RDBMS of one software, they have to contact and convince the severity of the problem to the software vendor; the vendor then prepares a project plan and price quote for implementation. The solution, most of the time is to add additional lines of code to tighten the data validation in the software both on server-side and client-side. In a real world scenario, data entry errors come up almost every day in an enterprise setup and almost always the manager reminds the data entry team to be careful next time for such error in order to avoid added cost and time contacting the software vendor. Over time, people not only forget but they leave company as well, this way the likelihood of same data entry error being showing up again is very high. Moreover, this is not the proper way to handle a situation in an efficient way especially if you aware of the claimed invention.

The algorithm and system claimed as invention here, puts the responsibility on the system rather than on employees that once a data entry error pattern is implanted in the system and then the system makes sure if it happens again, all the related dirty/erroneous records will be detected, encrypted and emailed over to the pre-defined correction agent's email account in MS Excel format. Not only that, a web interface supplements the delivery of report via email, in case the SMTP (Wikipedia: “Simple Mail Transfer Protocol (SMTP) is an Internet standard for electronic mail transmission across Internet Protocol networks”) server goes down or not available. Contrary to existing solutions which are all individual systems specific and none have an ‘error pattern in SQL statement format’ based solution at the RDBMS level under enterprise infrastructure for data quality improvement.

### SUMMARY OF THE INVENTION

Using claimed algorithm and system, every time the data entry error is detected a corresponding Structured Query Language (SQL) statement is generated by the system administrator. This SQL statement is the correct representation of the detected error. In other words, if the detected data entry error happens again, the system would be able to capture those dirty/erroneous records using this SQL statement. Generating the SQL statement for a specific situation described above is named as generating the pattern of the error.

The pattern is then fed to the system along with the related correction agent account/email address. At the end of the day, the system will be having all the error patterns and corresponding email addresses of correction agents.

The system is also having a Extraction-Transformation-Loading (ETL) process whose job is to bring data related to each pattern from actual production RDBMS systems into Automated Enterprise-wide Data Quality Improvement (AEDQI) system's local repository in the form of denormalized tables. Moreover, there is a scheduler process built-in the AEDQI system whose job is to wake up the AEDQI system's ETL process multiple times in 24 hours. The frequency of refreshment of AEDQI system's local database depends on the criticality of the production RDBMS based systems within an enterprise and the acceptable time delay in identifying and fixing data entry errors. At the very least once every early morning before AEDQI system's scanner process starts the scanning for error patterns in the local repository.

AEDQI system's at the very least, once early morning after the refreshment of local database, picks one error pattern (SQL statement) and executes it, if records detected, it prepares a MS Excel format report, encrypts it and emails it to the related correction agent's email account. It then moves to the next error pattern. All this takes place well before opening of the normal business day. It also logs an entry under the system feedback field of local database's table:s_schedule as shown in FIG. 3, along with timestamp. In case, it's not able to deliver via email due to unavailability of company's SMTP server, the report will still be available under the web-based interface of AEDQI system. The system will send an email only in case of detected dirty records. In a mission critical system, the AEDQI system's error pattern scanner can be triggered every time the refreshment of AEDQI system's local database completes.

### BRIEF DESCRIPTION OF THE DRAWINGS

FIG. 1 shows the algorithm used to develop the AEDQI System. Every time data entry error is detected, the system administrator generates the error pattern in SQL statement format and submits to the system along with correction agent's email address. The AEDQI scheduler triggers the AEDQI system's ETL process and then later AEDQI system's scanner a.k.a. Automatic Encrypted Report Delivery Vehicle (AERDV) process picks the first error pattern, scans the local repository; upon dirty/erroneous records identification, a report is generated in MS Excel format, encrypted and emailed to related correction agent's email address. AEDQI system's scanner process then moves over to the next error pattern. If no dirty records are found then no email goes out. Whether the email goes out or not a log entry is made in the AEDQI system's local database along with the timestamp which will be visible to the correction agent via AEDQI system's web interface. Once all error patterns are scanned, the system goes back in sleep mode waiting for the AEDQI system's scheduler to send a trigger again.

FIG. 2 describes how to implement the AEDQI algorithm in an enterprise. AEDQI system's local repository is based on three schemas. When AEDQI system's ETL process is refreshing Schema 1; Schema 2 and Schema Main are utilized by AEDQI system's web interface to serve the correction agents and system administrators. As soon as AEDQI system's ETL process completes the refreshment cycle, it swaps the Schema 2 and Schema 1 status in Schema Main's table where it says ‘status’ field in FIG. 5. This way, all the future requests coming through AEDQI system's web interface, goes to the most recently refreshed schema. AEDQI system's automatic encrypted report delivery vehicle (AERDV) is the scanner process which picks the error pattern from local database's ACTIVE schema: either Schema 1 or Schema 2 and scans the related refreshed table for dirty/erroneous records. If dirty records are found then MS Excel format file is generated and then AEDQI's AERDV process encrypts the dirty records MS Excel file and via enterprise's SMTP server emails the file to related correction agent. The figure depicts the AEDQI System's Control Panel (CP) accessible only to the System's Administrator (SA). Using CP, SA can create new correction agents accounts, submit error patterns, attach error pattern(s) with correction agent(s) and schedule error patterns for daily, weekly or monthly email delivery.

FIG. 3 depicts the entity relationship diagram of Schema 1 and Schema 2. Both Schema 1 and Schema 2 are exactly identical schemas. If one is being refreshed by AEDQI system's ETL process, the other one is being used to serve the correction agents and system administrators. s_security table contains the information of the correction agents and system administrators. s_report table is for error patterns; each pattern will be given a user-friendly name and related SQL statement. s_report_mem_relation table stores information about the relationship between correction agent and related error patterns. s_schedule table contains information needed by AEDQI system's scanner process a.k.a. Automatic Encrypted Report Delivery Vehicle (AERDV). Every day the process looks for all those error patterns where the next_run_date is equal to today's date. Once the completion of execution of one error pattern, the AEDQI system's scanner process places a tomorrow's date into the next_run_date for that particular error pattern.

FIG. 4 shows AEDQI system's use case starting from, error is detected that someone entered ID equal to 4 characters. Based on company policy, the ID length is always 9 characters. The System Administrator converts this error pattern into SQL statement and using AEDQI system's Control Panel (CP) submits to Schema 1 and Schema 2 in the s_report table as described in FIG. 3. Schema Main contains only one table: s_status and contains the information about which schema is in use by web interface (GUI) and which one is not in use. The one that is not in use, is picked up AEDQI system's ETL process for refreshment i.e. bringing latest information from production systems to AEDQI system's local database. After the completion of AEDQI system's ETL refreshment process, it swaps the information in s_status table along with last refreshment date and time. This timestamp appears on the AEDQI system's web graphical user interface (GUI) for correction agents. Depending upon which schema is active, the AEDQI Automated Encrypted Report Delivery Vehicle a.k.a. scanner process, picks the error pattern and if dirty records found then MS Excel format file is generated and then AEDQI encrypts the dirty records MS Excel file and via enterprise's SMTP server emails the file to related correction agent.

FIG. 5 describes the design of s_main table in Schema Main of AEDQI system's local repository. The status field will be having either ACTIVE or INACTIVE. After the completion of AEDQI system's ETL process; the process swaps these values. AEDQI system's ETL process always picks up the INACTIVE schema and once the refreshment cycle completes, the process changes the status field value, making the recently refreshed schema ACTIVE and older ACTIVE schema INACTIVE. The ACTIVE schema either Schema 1 or Schema 2, is utilized by AEDQI system's scanner/AERDV process for the detection of error pattern.

### DETAILED DESCRIPTION OF THE INVENTION

There are two things presented in this claimed invention, one the algorithm and the other is the system. These two things are related with each other as they have the same purpose which is data quality improvement, not just in one system but at the enterprise level. The system is the actual, real world implementation of the algorithm. Let's first take a look at the Automated Enterprise-wide Data Quality Improvement (AEDQI) algorithm and then we talk about the AEDQI system—which is the implementation of the algorithm. There could be multiple ways; the AEDQI algorithm can be implemented. The claimed system is one of those implementations.

In an enterprise environment, there are numerous departments and in each department there could be numerous softwares under utilization backed by Relational Database Management System (RDBMS). Every software comes with its own data validation rules at the data entry level. But these rules are limited to the range of values specific to fields, data types based and known common data entry errors as the time of design of software. Once the software is actually placed in the production, there will be new data entry error scenarios almost every other day. Using the AEDQI algorithm and system we can shift the burden from employees' memory for not to repeat the same error again to the AEDQI system.

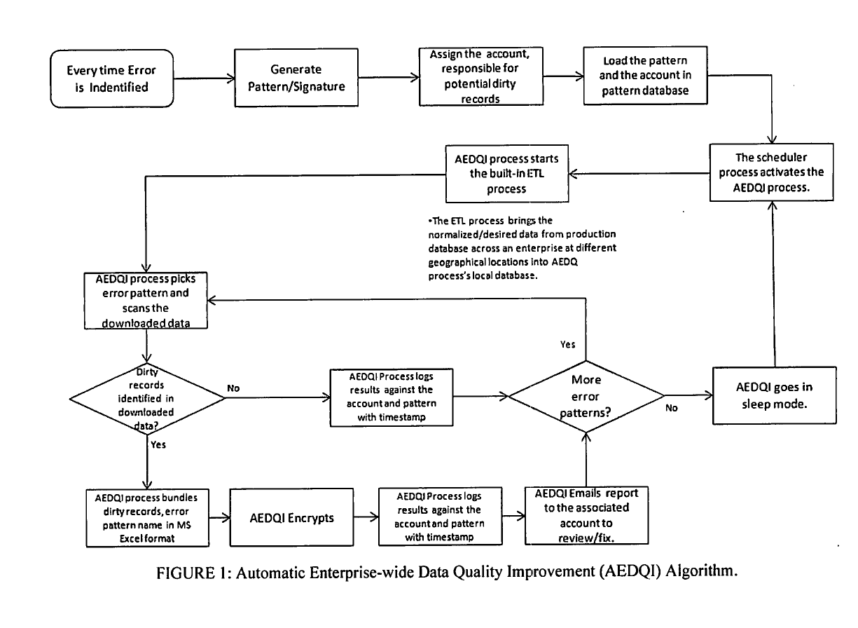

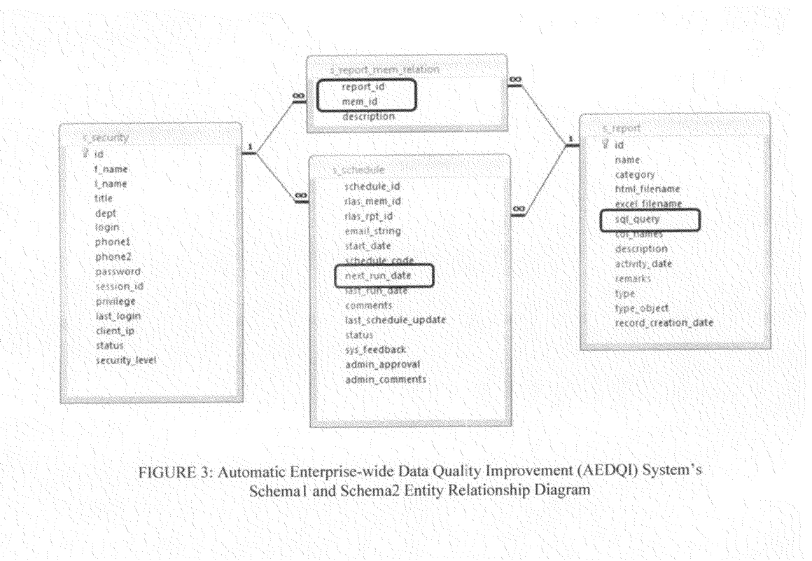

Let's start the discussion with a look at the AEDQI algorithm as shown in FIG. 1. Every time a data entry error is detected the AEDQI system's administrator will generate a pattern in SQL statement format. If the related correction agent's email and account is not already registered, then the AEDQI system's administrator will create an account as well. Then he will assign the error pattern to the correction agent account. In case more data entry patterns are detected in future for the same correction agent then all AEDQI system's administrator has to do is to assign the pattern in SQL format to that correction agent i.e. no need to recreate the correction agent's account again. The relationship between SQL error pattern and correction agent takes place in s_report_mem_relation table as shown in FIG. 3. The data entry error pattern in SQL format goes in s_report table where each pattern is given a user-friendly name as well, also depicted in the same FIG. 3. Furthermore, the correction agent's account information including email address, login and password will be placed in s_security table. It's an industry standard for the security sake that the password field's data is encrypted using one way encryption e.g. MD5 with salt. Initial password is generated by AEDQI system's administrator which is later changed by the correction agent after first successful login. AEDQI scheduler process triggers the AEDQI Extraction-Transformation-Loading (ETL) process.

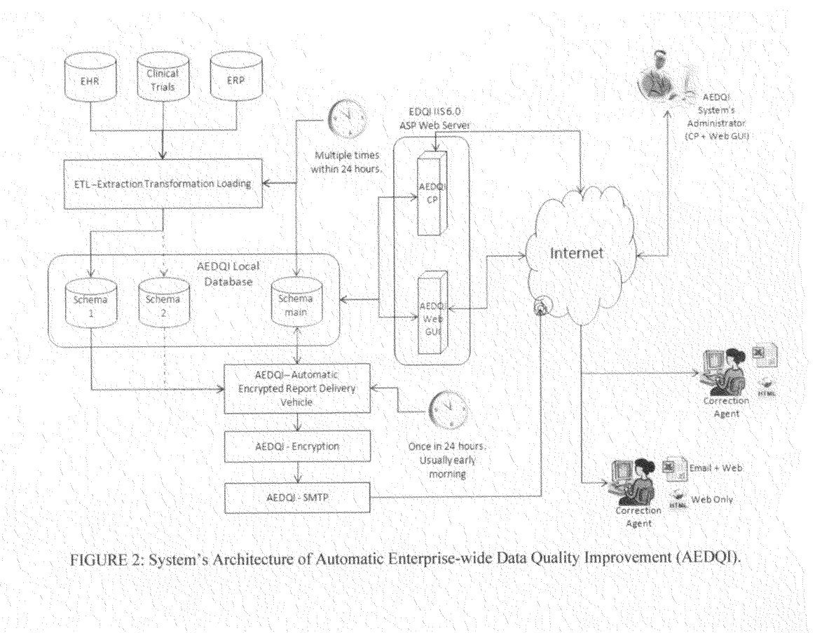

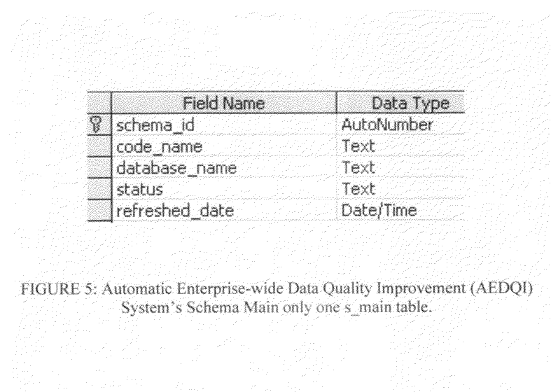

The AEDQI scheduler process's frequency can be altered at the database level under Schema Main as shown in FIG. 2. At the very least, the AEDQI scheduler process triggers the AEDQI ETL process once in 24 hours and usually very early morning e.g. 2 A.M. Every time we add an error pattern in SQL format to the AEDQI system's local repository, we also have to make certain that related data is available in the same local repository on which the error pattern is applicable. For example, if the error pattern is to make sure there are is no period “.” in the first and last names of the employees in the database then AEDQI system administrator has to make sure that all the first and last names are available in the local repository. And to do that, AEDQI system administrator will setup an AEDQI ETL query in a way to bring the data from production database to the AEDQI system's local database. In real world situation, where we have hundreds of error patterns, AEDQI system's administrator will prepare a one or more ETL queries to bring the data from highly normalized production database schemas to one or more highly denormalized tables in the AEDQI system's local repository. Once the AEDQI system's ETL process completes, it triggers the AEDQI system's Automated Encrypted Report Delivery Vehicle (AERDV) process as shown in FIG. 2 a.k.a. the AEDQI system's scanner process as shown in FIG. 1. The AEDQI system's ETL process refreshes the either Schema 1 or Schema 2 as shown in FIG. 2 depending upon which ever is INACTIVE. The ACTIVE schema is used to serve the AEDQI system's web GUI. As shown in FIG. 5, status field of s_main table is used to store ACTIVE and INACTIVE values. The s_main table is the part of Schema Main. Once the AEDQI system's ETL completes the refreshment cycle it swaps the ACTIVE and INACTIVE status in Schema Main with a timestamp of completion of last refreshment cycle.

The AEDQI system's web GUI will be having information about the date and time of last refreshment and it will come from Schema Main table. In a high quality, mission critical systems, AEDQI system's scheduler process can be made to trigger the AEDQI system's ETL process multiple times in 24 hours. But the time gap between the start of two consecutive refreshment cycles should be well above the time required to complete one full refreshment cycle.

The AEDQI system's scanner process will pick one data entry error pattern which is in SQL statement format and executes it against the recently refreshed schema. Upon detection of erroneous records—which are records with positive data entry error, the process prepares a report in MS Excel format and then encrypts it utilizing native MS Excel native technique through .NET coding using correction agent's last 4 digits of Social Security Number (SSN) or 4 digits of year part of date of birth provided whichever is easily available and depending upon companies policy. The dirty/erroneous records encrypted MS Excel file is assigned the same name as the user friendly name of data entry error pattern in s_report table as shown in FIG. 3. The encrypted report is then emailed over to the correction agent for review and fixing those records in production RDBMS. The AEDQI system's scanner process also logs an entry with timestamp under sys_feedback field of s_schedule table as shown in FIG. 3 against the executed data entry error pattern. If no dirty records are found then only the feedback is submitted by the system and no email goes out.

The selection of data entry error patterns depends on the next_run_date field of s_schedule table as shown in FIG. 3. The AEDQI system's scanner process creates the dataset of all those data entry error patterns where the current date is equal to the date in the next_run_date field. The process then picks one error pattern, executes the protocol: dirty records to encryption and email to correction agent; then picks the second error pattern and so on. Upon execution of all error pattern SQL statements, the AEDQI system's scanner process goes into the sleep mode.

The error pattern SQL statements can be placed on a “daily”, “weekly” or “monthly” schedule plan. Most of the times, it's daily, therefore, after completing the execution of one error pattern, the AEDQI system's scanner process updates it's the next_run_date to tomorrow's date in the s_schedule table of Schema 1 and Schema 2.

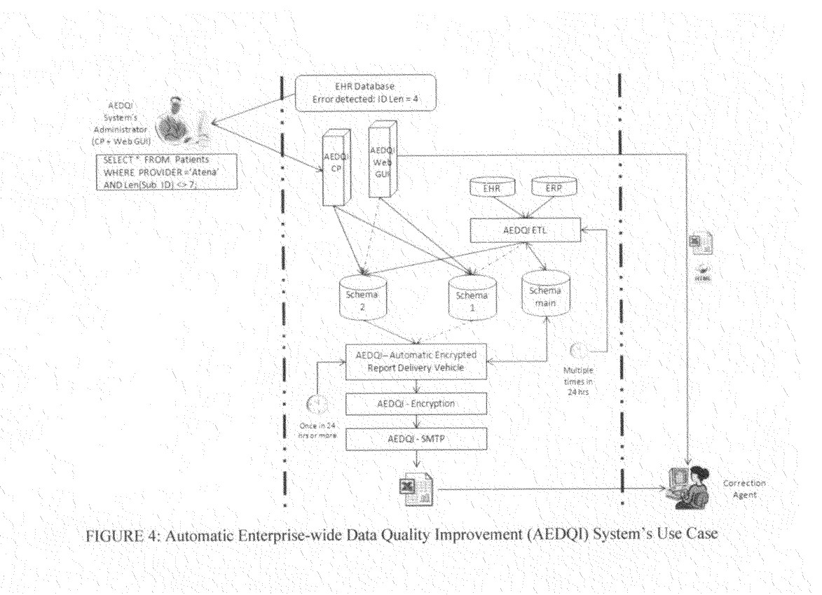

The FIG. 4 describes the whole AEDQI system's use case where the data entry error is reported to the AEDQI system's administrator. The error was that the subscriber ID with size of 4 characters, entered by someone in the data entry team. The AEDQI system's administrator, analyzed the database and learned that under ‘Atena’ medical insurance provider code the subscriber's id is always having 7 characters length. Therefore, the AEDQI system's administrator generates the following error pattern in SQL statement format.

### SELECT*

FROM patients
WHERE provider=‘Atena’ AND Len(subscriber_id)< >7;
This error pattern submitted to the Schema 1 and Schema 2 utilizing AEDQI system's administrator control panel (CP). The SQL query will specifically go into the sql_query field of s_report table as shown in FIG. 3. An online form is provided under AEDQI system's CP after login which will not only takes the error pattern in SQL statement format but also the user-friendly name of the error pattern as well. Pressing the submit button will populate the s_report table in Schema 1 and Schema 2.

Using the same AEDQI system's CP, the administrator will create the account for related correction agent which will be again an online form and after pressing the submit button the data goes straight into s_security table. The next step will be assignment of error pattern to the correction agent. Again, another online form with two drop down menus for building relationship; one for list of existing error patterns' user-friendly names and other for list of existing correction agents. Upon appropriate selections, the AEDQI system's administrator will click the submit button and the data will be recorded in the s_report_mem_relation table of Schema 1 and Schema 2. With the AEDQI algorithm's implementation architecture like this, virtually infinite number of error patterns can be submitted along with virtually infinite number of correction agents without the recompilation of code or needing any assistance from programmer. As more and more errors are being detected over time, the AEDQI system's administrator will keep populating the AEDQI's local repository based on the same protocol. This way company or department's data quality goal will be independent from the lessons learnt by the employees over the years.

After building the relationship between the correction agent and related error pattern; the AEDQI system's administrator will add the pattern to the s_schedule table utilizing AEDQI system's CP. The AEDQI system's Automatic Encrypted Report Delivery Vehicle a.k.a. the scanner process will utilize the s_schedule table's next_run_date field to find out which error patterns are due to be scanned today e.g. if today is 03-15-2012, the AEDQI system's scanner process will create the recordset of all those records where next_run_date is 03-15-2012. Once having this recordset, it will take first record and it's error pattern id shown as in the FIG. 3 rlas_rpt_id. AEDQI system's scanner process then locate the error pattern in SQL statement under s_report table and then execute it against the ACTIVE schema either Schema 1 or Schema 2. If errors are detected then the process prepares are MS Excel report, encrypts it utilizing native MS Excel technique programmatically. This way when the correction agent receives the MS Excel file via email he/she does not need to use any other third party software to decrypt it.

The AEDQI system's scanner process after creating the encrypted MS Excel file, the process emails the report utilizing the SMTP server to the email address provided in email_string field of the same record. The process then writes the feedback into the sys_feedback field of the s_schedule table.

In case, no records are found after the execution of error pattern SQL statement, then only feedback is recorded in the sys_feedback field of s_schedule table and no email goes out. This completes the AEDQI system's scanner process's protocol for first record in the recordset described in paragraph [032]. The process then moves to second record and so on. After the completion of protocol for the last record in the recordset, the AEDQI system's scanner process goes back in the sleep mode as shown in FIG. 1, awaiting to be get back live again based on the frequency set by the AEDQI system's administrator.

AEDQI system's Web Graphical User Interface (GUI) and CP can be placed under Microsoft Internet Information Server (IIS) a.k.a. web server or on separate IIS. These are two separate web applications. AEDQI system's CP is meant sole for the AEDQI system's administrators whereas AEDQI system's Web GUI is for both administrators and correction agents.

As depicted in FIG. 4, the output of the process is MS Excel file and HTML view if the correction agent will utilize the AEDQI system's web GUI and Encrypted MS Excel files will be delivered automatically by AEDQI system's Automatic Encrypted Report Delivery Vehicle (AERDV) provided the error pattern resulted in one or more dirty records or faulty records. There are two separate time triggers a.k.a. the schedulers built-in the processes: one for AEDQI ETL and other for AEDQI AERDV. Moreover as mentioned previously, in a high quality, mission critical systems, AEDQI system's scheduler process can be made to trigger the AEDQI system's ETL process multiple times in 24 hours or both can be scheduled to be activated multiple times in 24 hours but the important thing to remember is that the time gap between the start of two consecutive refreshment cycles of AEDQI ETL process should be well above the time required to complete one full refreshment cycle. “Well above” because, remember, during the peak hours, the connection between AEDQI ETL process and production RDBMS may be slower than during off peak hours.

What I claim as my invention is:

1. An algorithm as shown in FIG. 1 and its implementation—a system as shown in FIG. 2, utilizing which:
error pattern can be submitted in SQL statement format to the system's local repository by system administrator along with the account information of correction agent which includes his/her email address;
the system administrator then assign the said error pattern with the correction agent utilizing web-based Control Panel (CP);
then system administrator schedules the error pattern for delivery via email either daily, weekly or monthly;
the system is also having an Extraction-Transformation-Loading (ETL) process;
and scanner process a.k.a. as Automatic Encrypted Report Delivery Vehicle (AERDV) process;

2. The system of claim 1, also has:
two scheduler processes; one built into ETL process and other built into AERDV process;
web-based graphical user interface (GUI) as shown in FIG. 2;
wherein said local repository in claim 1, comprised of three schemas: Schema 1, Schema 2 and Schema Main.

3. The system of claim 1, wherein said AERDV process a.k.a. scanner process, picks up the error pattern SQL statement and executes it against the local repository (schema 1 or schema 2 whichever is ACTIVE); upon detection of related records, the process generates the MS Excel file, encrypts it and then emails it to the related correction agent's email address; once all error patterns have followed this protocol, the AERDV process goes into the sleep mode; later activated again by the scheduler process for AERDV of claim 2.

4. The AERDV process of claim 3 can be activated multiple times in 24 hours but under most circumstance only once early morning but not more than the number of times ETL process is triggered.

5. The algorithm and system of claim 1, wherein said local repository consists of three schemas: Schema 1, Schema 2 and Schema Main; the Schema 1 and Schema 2 are identical schemas whereas Schema Main contains refreshment cycle information along with which schema is ACTIVE or which one is INACTIVE between schema 1 and schema 2 as shown in FIG. 5; the error patterns and correction agents' information submitted by system administrator via system's web CP goes into both Schema 1 and Schema 2.

6. The algorithm and system of claim 1, wherein said ETL process is responsible of bringing data related to the error patterns from one or more production RDBMS to the local repository into Schema 1 or Schema 2 whichever status is INACTIVE in Schema Main.

7. The ETL process of claim 1, after refreshing INACTIVE schema (either Schema 1 or Schema 2) swaps the status in the Schema Main's table as shown in FIG. 5; therefore, after refreshment cycle completion INACTIVE schema becomes ACTIVE and ACTIVE schema becomes INACTIVE.

8. The AERDV process of claim 3 once activated by built-in scheduler of claim 2, will always picks the ACTIVE schema either Schema 1 or Schema 2 by reading the “status” field as shown in FIG. 5 of Schema Main table.

9. The ETL process of claim 1 can be scheduled to be triggered multiple times in 24 hours depending upon the mission critically of the production RDBMS but the time gap between the start of two consecutive refreshment cycles of AEDQI ETL process should be well above the time required to complete one full refreshment cycle.

10. The Schema 1 and Schema 2 wherein said in claim 2 contain at the minimum of four tables and these tables are connected with each other in fashion as shown in the entity relationship diagram in FIG. 3.

11. The Schema Main contains wherein said in claim 2 contains at the minimum of one table whose design view is shown in FIG. 5.

12. The algorithm and system of claim 1, wherein said error pattern submitted in SQL statement format, is saved by first assign it a user-friendly name by filling in an online form of CP; the user-friendly name goes into the name field and error pattern in SQL statement format goes into sql_query field of s_report table of Schema 1 and Schema 2 as shown in FIG. 3.

13. The algorithm and system of claim 1, wherein said correction agent account along with email address is created by filling online form of CP and submitted information goes into s_security table of both Schema 1 and Schema 2.

14. The algorithm and system of claim 1, wherein said ‘assign the said error pattern with the correction agent’ takes place by filling an CP form online and the submitted data goes into the s_report_mem_relation table of both Schema 1 and Schema 2.

15. The algorithm and system of claim 1, wherein said ‘schedules the error pattern for delivery via email’ is done by filling an online form of CP and submitted data goes into the s_schedule table alone with next_run_date and schedule_code which is daily, weekly or monthly of both Schema 1 and Schema 2; by default it's daily.

16. The AERDV process of claim 3, picks only those error patterns for scan where the today's date is equal to next_run_date as shown in FIG. 3; after completing each error pattern scan logs an entry in the sys_feedback field of s_schedule table of Schema 1 and Schema 2 along with date and time.

17. The AERDV process of claim 3, after completing an error pattern scan for schedule_code as ‘daily’; it updates the next_run_date to tomorrows date.

18. The web-based GUI of claim 2, contains a hyper-link for a logged in user to see all the system feedback of related scheduled error patters; the data for this dynamically generated HTML document comes from s_schedule table of the ACTIVE schema.

19. The web GUI of claim 2 is a web-server based application, providing another mean for the correction agent to download reports containing erroneous data in MS Excel format or view the data utilizing HTML interface with searching and sorting functions built-in.
